(19) United States
(12) Patent Application Publication
(10) Pub. No.: US 2025/0092645 A1
(43) Pub. Date: Mar. 20, 2025

(54) ATTACHMENT OF A WEAR MEMBER

(71) Applicant: Talon Engineering SDN. BHD, Ipoh (MY)

(72) Inventors: Wai Hoong Yeck, Ipoh (MY); Neil Dennis, Claremont (AU)

(21) Appl. No.: 18/562,232

(22) PCT Filed: Jun. 1, 2022
(86) PCT No.: PCT/AU2022/050537

§ 371 Date: Nov. 17, 2023

(30) Foreign Application Priority Data
Jun. 4, 2021 (AU) 2021901661
Jun. 1, 2022 (WO) PCT/AU2022/050537

(51) Int. Cl. E02F 9/28

(52) U.S. Cl. CPC E02F 9/2833; E02F 9/2883

(57) ABSTRACT

A method of locking a wing shroud to a cable shovel includes the use of a lock having two locking members arranged to be bolted together. Each locking member has an angled collar arranged to bear against an angled surface of the wing shroud. Tightening of the bolt causes the collars to move towards each other, resulting in the wing shroud being forced in a rearward direction to lock the shroud onto the wing of the cable shovel bucket.

### FIELD OF THE INVENTION

The present invention relates to a locking assembly for attachment of ground engaging tools to earthmoving equipment. The present invention has been designed for the attachment of a wing shroud to a bucket of a cable shovel, but is considered to have wider application in the attachment of ground engaging tools.

### BACKGROUND TO THE INVENTION

Buckets of excavating equipment are subject to significant abrasive wear during use. For this reason, replaceable ground engaging tools (GET) are located about the buckets in the areas most susceptible to wear. A number of different GET are used, including wing shrouds, heel shrouds, lip shrouds, adaptors, wear plates, teeth and corner shrouds.

The connection of shrouds such as lip shrouds and wing shrouds to bucket edges has presented a consistent challenge, and there are many different systems currently available which seek to perform this task in an efficient manner.

Broadly speaking, GET attachment systems fall into two classes: pinned systems and external systems. Pinned systems use an aperture which passes through a wall of the bucket, with some sort of locking device located in the aperture. External systems use some external formation on the bucket, such as a boss, to provide a bearing surface against which a lock can locate.

In general, external systems are useful for relatively small forces (or smaller GET components). When the relevant forces are relatively large, pinned systems are preferred.

A traditional pinned system uses a wedge-and-spool arrangement. In such an arrangement, the pin consists of two members which bear against each other along a tapered connection, with an activating bolt holding the members together. Turning of the bolt causes the members to move relative to each other along the tapered connection, increasing the effective width of the pin. Such a system can be tightened whereby the pin is locked in position within the bucket aperture.

Wedge and spool systems are efficient in locking the pin within the bucket aperture and thus preventing loss of the GET. Traditional systems have limited capability to adjust to wear of the GET, however, and therefore even when secure against loss the GET can be relatively loose and prone to vibration or rattling.

The present invention seeks to provide a locking system for wing shrouds and similar GET which alleviates, at least in part, some of the above problems.

### SUMMARY OF THE INVENTION

According to one aspect of the present invention there is provided a lock for a ground engaging tool, the lock having a first locking member, a second locking member and a tightening element;
the first locking member having an axial bore;
the second locking member having an axial bore;
the tightening element arranged to locate with the axial bores of the first and second locking members, defining an axial direction of the lock;
a transverse plane of the lock being defined as perpendicular to the axial direction;
the first locking member having at least one guiding surface, the guiding surface facing generally towards the second locking member, the guiding surface being located on a lateral side of the first locking member, the guiding surface being oriented at an acute angle relative to the transverse plane.

The first locking member preferably has two guiding surfaces, the two guiding surfaces being located on opposite transverse sides of the first locking member, the two guiding surfaces being parallel to each other and level with each other; that is, being co-planar.

The acute angle is preferably between 20° and 60°. It is preferred that the acute angle be between 20° and 45°. It is most preferred that the acute angle be about 30°.

The first locking member preferably has an outer facing surface, the outer facing surface facing generally away from the second locking member, the outer facing surface being generally parallel to the guiding surface.

In use, the or each guiding surface is arranged to bear against a corresponding guiding surface of the ground engaging tool and thus provide a rearward force on the ground engaging tool, and the outer facing surface is arranged to face towards a corresponding inner facing surface of the ground engaging tool.

It is preferred that the outer facing surface is located on a lateral side of the first locking member. The outer facing surface may be located on two opposite lateral sides of the first locking member.

In a preferred embodiment, the first locking member has an axially aligned body portion, and a collar extending laterally of the body portion at an outer end thereof, the collar being oriented at the acute angle relative to the transverse plane. In this embodiment the collar has an outwardly facing surface forming the outer facing surface of the first locking member, and at least one inwardly facing surface forming the guiding surface of the first locking member.

The collar preferably includes a front wall extending laterally across the first locking member. The front wall preferably has an outer surface which is perpendicular to the transverse plane.

The body portion may have a head receiving region at an outer axial end thereof. The head receiving region may be generally in the shape of a right triangular prism, with a base perpendicular to the axial bore, a rear wall parallel to the axial bore, and an inclined top edge which forms a hypotenuse when viewed from the side. The top edge is preferably included at the acute angle relative to the transverse plane.

The second locking member preferably has at least one guiding surface, the guiding surface facing generally towards the first locking member, the guiding surface being located on a lateral side of the second locking member, the guiding surface being oriented at an acute angle relative to the transverse plane. It is preferred that the acute angle of the second locking member guiding surface be the same as that of the first locking member guiding surface.

The arrangement is such that the guiding surface of the second locking member is a reflection of the guiding surface of the first locking member about the transverse plane. In other words, the guiding surface of the first locking member is angled with respect to the guiding surface of the second locking member by an angle equal to the sum of the acute angles of the first locking member guiding surface and the second locking member guiding surface.

It is preferred that the second locking member has two guiding surfaces, located on opposite lateral sides of the second locking member.

The second locking member preferably has an outer facing surface, the outer facing surface facing generally away from the first locking member, the outer facing surface being generally parallel to the guiding surface of the second locking member.

It is preferred that the outer facing surface is located on a lateral side of the second locking member. The outer facing surface may be located on two opposite lateral sides of the second locking member.

In a preferred embodiment, the second locking member has an axially aligned body portion, and a collar extending laterally of the body portion at an outer end thereof, the collar being oriented at the acute angle relative to the transverse plane. In this embodiment the collar has an outwardly facing surface forming the outer facing surface, and an inwardly facing surface forming the guiding surface.

It is preferred that the first locking member has an axially extending locating portion, and the second locking member has a complementary receiving portion. Advantageously, the cooperation of the locating portion and the receiving portion acts to restrain relative rotation of the first and second locking portions about the tightening element. Additionally, this cooperation acts to strengthen the lock and reduce the risk of bending the tightening element.

Preferably the tightening element is a bolt. In a preferred embodiment, the bolt is externally threaded, and one of the first and second locking members includes an enlarged region in which a head of the bolt may be received, and the other of the first and second locking members has an internally threaded bore in which a shank of the bolt can be engaged.

The enlarged region is preferably associated with a generally planar front surface and a generally planar rear surface. The front surface and the rear surface may be parallel to each other, and perpendicular to the transverse plane.

According to a second aspect of the present invention there is provided a ground engaging tool having a longitudinal direction, the ground engaging tool having two legs arranged to locate about an excavator bucket edge, a first leg including a first lock receiving aperture and a second leg including a second lock receiving aperture, the first and second lock receiving apertures being aligned;
the first lock receiving aperture having two lateral sides,
at least one lateral side including a guiding surface, the guiding surface being oriented at a first acute angle relative to the longitudinal direction, the guiding surface facing away from the second lock receiving aperture; and
the first lock receiving aperture including an inner facing surface, the inner facing surface being oriented at a second acute angle relative to the longitudinal direction, the inner facing surface facing towards the second lock receiving aperture.

The first and second acute angles are preferably between 20° and 60°. It is preferred that the first and second acute angles are between 20° and 45°. It is most preferred that the first and second acute angles are both about 30°.

Preferably the first acute angle and the second acute angle are the same; that is, the guiding surface is parallel to the inner facing surface.

It is preferred that the inner facing surface extends across a front of the first lock receiving aperture, from one lateral side to the other.

It is preferred that both lateral sides include a guiding surface, the two guiding surfaces being parallel to each other and co-planar.

The first lock receiving aperture preferably has a generally planar rear surface, the rear surface being perpendicular to the longitudinal direction. The first lock receiving aperture preferably has a front surface with at least two portions, a first portion extending inwardly from an outer surface of the ground engaging tool, the first portion being parallel to the rear surface, and a second portion extending inwardly and forwardly from the first portion, the second portion forming the inner facing surface. The front surface may include a third portion parallel to the first portion, the third portion extending from a forward-most edge of the second portion towards the second lock receiving aperture.

It is preferred that the guiding surface extends from the rear surface to a termination point, the termination point being located about midway between the rear surface and a forward-most edge of the second portion of the front surface.

The inner facing surface is preferably parallel to the guiding surface.

The second lock receiving aperture may include two lateral sides, at least one lateral side including a guiding surface, the guiding surface being oriented at an acute angle relative to the longitudinal direction, the guiding surface facing away from the first lock receiving aperture.

It is preferred that both lateral sides include a guiding surface, the two guiding surfaces being parallel to each other and co-planar.

The second lock receiving aperture preferably includes an inner facing surface, the inner facing surface being oriented at the acute angle relative to the longitudinal direction, the inner facing surface facing towards the first lock receiving aperture.

It is preferred that the inner facing surface extends across a front of the second lock receiving aperture, from one lateral side to the other.

The second lock receiving aperture preferably has a generally planar rear surface, the rear surface being perpendicular to the longitudinal direction. The second lock receiving aperture preferably has a front surface with at least two portions, a first portion extending inwardly from an outer surface of the ground engaging tool, the first portion being parallel to the rear surface, and a second portion extending inwardly and forwardly from the first portion, the second portion forming the inner facing surface. The front surface may include a third portion parallel to the first portion, the third portion extending from a forward-most edge of the second portion towards the first lock receiving aperture.

The third portion of the front wall of the second lock receiving aperture is preferably deeper than the third portion of the front wall of the first lock receiving aperture.

It is preferred that the guiding surface extends from the rear surface to a termination point, the termination portion being located about midway between the rear surface and a forward-most edge of the second portion of the front surface.

The inner facing surface is preferably parallel to the guiding surface.

According to a third aspect of the present invention there is a provided a method of attaching a ground engaging tool to a bucket edge, the method including the steps of:
providing at least one aperture passing through the bucket edge;
locating the ground engaging tool about the bucket edge such that two legs of the ground engaging tool are positioned about the excavator bucket edge, a first leg including a first lock receiving aperture and a second leg including a second lock receiving aperture, the first and second lock receiving apertures being aligned with the aperture of the bucket edge, the first lock receiving aperture having a guiding surface oriented at an acute angle relative to a longitudinal direction of the ground engaging tool;
locating a first locking member in the first receiving aperture such that a guiding surface of the first locking member is oriented at an acute angle relative to the longitudinal direction of the ground engaging tool;
locating a second locking member in the second receiving aperture; connecting axial bores of the first and second locking members by a tightening element; and
tightening the tightening element to cause the guiding surface of the first locking member to bear against the guiding surface of the first lock receiving aperture, thus urging the ground engaging tool rearwardly relative to the bucket edge.

Preferably the second lock receiving aperture has a guiding surface oriented at an acute angle relative to the longitudinal direction of the ground engaging tool; the step of locating the second locking member in the second receiving aperture is done such that a guiding surface of the second locking member is oriented at an acute angle relative to the longitudinal direction of the ground engaging tool; and tightening of the tightening element causes the guiding surface of the second locking member to bear against the guiding surface of the second lock receiving aperture.

It is preferred that the first lock receiving aperture has an inner facing surface, and that the first locking member has an outer facing surface arranged to bear against the inner facing surface. The inner facing surface and the outer facing surface may be oriented at the acute angle, such that the outer facing surface moves along the inner facing surface during tightening of the tightening element.

It is also preferred that the second lock receiving aperture has an inner facing surface, and that the second locking member has an outer facing surface arranged to bear against the inner facing surface. The inner facing surface and the outer facing surface may be oriented at the acute angle, such that the outer facing surface of the second locking member moves along the inner facing surface of the second lock receiving aperture during tightening of the tightening element.

### BRIEF DESCRIPTION OF THE DRAWINGS

It will be convenient to further describe the invention with reference to preferred embodiments of the present invention. Other embodiments are possible, and consequently the particularity of the following discussion is not to be understood as superseding the generality of the preceding description of the invention. In the drawings:

FIG. 1 is an exploded view of a locking system for a wing shroud in accordance with the present invention;

FIG. 2 is an upper perspective of a first locking member from within the locking system of FIG. 1;

FIG. 3 is a first side view of the first locking member of FIG. 2;

FIG. 4 is a second side view of the first locking member of FIG. 2;

FIG. 5 is a cross section through the first locking member of FIG. 2;

FIG. 6 is a first perspective of a second locking member from within the locking system of FIG. 1;

FIG. 7 is a second perspective of the second locking member of FIG. 6;

FIG. 8 is a cross section through the second locking member of FIG. 6;

FIG. 9 is an exploded view of a lock from within the locking system of FIG. 1;

FIG. 10 is an assembled view of the lock of FIG. 9;

FIGS. 11a and 11b are cross sections through the lock of FIG. 9 showing a bolt in two different rotational positions;

FIG. 12 is a schematic representation of a portion of a bucket edge from within the locking system of FIG. 1;

FIG. 13 is a side view of the bucket edge of FIG. 12;

FIG. 14 is a first perspective of a wing shroud from within the locking system of FIG. 1;

FIG. 15 is a second perspective of the wing shroud of FIG. 14;

FIG. 16 is a third perspective of the wing shroud of FIG. 14;

FIG. 17 is a plan view of the wing shroud of FIG. 14;

FIG. 18 is a first lock receiving aperture within the wing shroud of FIG. 14;

FIG. 19 is a second first lock receiving aperture within the wing shroud of FIG. 14;

FIG. 20 is a cross section through the wing shroud of FIG. 14;

FIG. 21 is a cut-away view through the wing shroud of FIG. 14; and

FIGS. 22 to 33 are views of the locking system of FIG. 1 during assembly and use.

### DETAILED DESCRIPTION OF PREFERRED EMBODIMENTS

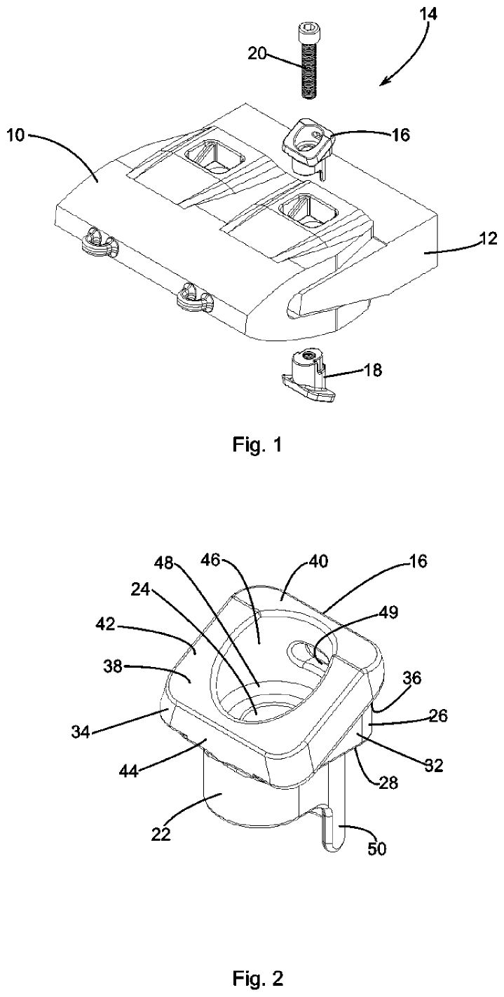

Referring to the Figures, FIG. 1 shows a wing shroud 10 being located about a side edge 12 (or “wing”) of an excavator bucket. The wing shroud 10 is locked onto the bucket edge 12 by means of a lock 14 including a first locking member 16, a second locking member 18, and a tightening element being a bolt 20.

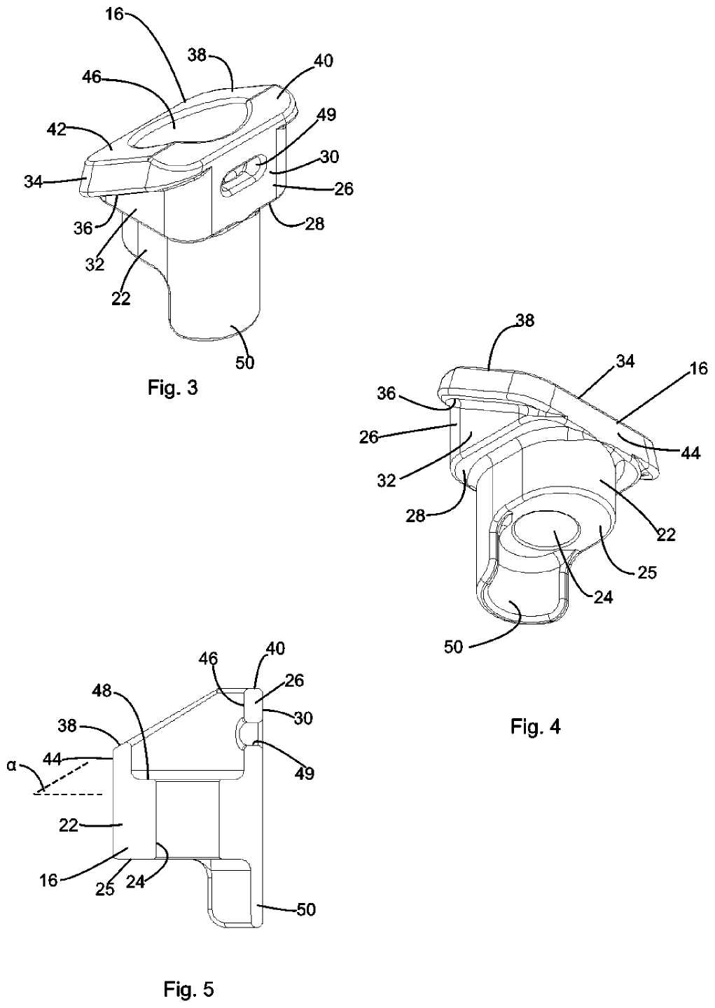

The first locking member 16 is shown in FIGS. 2 to 5. The first locking member 16 has a body portion 22 which is generally prismatic based on a stadium (an oval with straight sides). The body portion 22 has an axial bore 24 passing therethrough. The body portion 22 has an inner end 25.

The body portion 22 has a head receiving region 26 at an outer axial end thereof. The head receiving region 26 is generally in the shape of a right triangular prism. The head receiving region 26 has a base 28 perpendicular to the axial bore 24, the base 28 being approximately square. The head receiving region 26 has a rear wall 30 parallel to the axial bore 24, and perpendicular to the straight sides of the body portion 22. The head receiving region 26 has an inclined top edge which forms a hypotenuse when viewed from the side. The head receiving region 26 has two right-triangular side walls 32.

A collar 34 extends around the inclined top edge of the head receiving region 26. The collar 34 is angled at an acute angle a relative to the base 28 of the head receiving region 26. In the embodiment of the drawings the acute angle a is about 30°.

The collar 34 extends beyond the head receiving region 26 on two lateral sides of the first locking member 16. This creates a lip on each side, each lip having a surface facing towards an inner end of the body portion 22. These surfaces act as guiding surfaces 36 for the first locking member 16. The guiding surfaces 36 extend away from, and perpendicular to, the side walls 32 of the head receiving region 26.

The collar 34 has a generally annular upper surface 38. The upper surface 38 has a flattened rear portion 40, which extends forward of the rear wall 30 and is parallel to the base 28. The remainder of the upper surface 38 forms an outer facing surface 42 for the first locking member 16. The outer facing surface 42 is parallel to the guiding surface 36; that is, is angled at the acute angle a relative to the base 28.

The collar 34 has a front wall 44 parallel to the rear wall 30 of the head receiving region 26.

The axial bore 24 opens into a wider cylindrical aperture 46 in the head receiving region 26. This results in an annular seat 48 being created at the base of the wider cylindrical aperture 46, around a mouth of the axial bore 24.

A slot 49 is located at a rear of the cylindrical aperture 46, beneath the flattened rear portion 40. The slot 49 extends from the cylindrical aperture 46 through to the rear wall 30. The slot 49 is shaped to receive a tool such as a flathead screw driver to assist in removal of the lock 14 after use.

The first locking member 16 has an axially extending locating portion being a skirt 50 extending from an inner end thereof. The skirt 50 is located on the side of the first locking member 16, and has an outer shape consistent with the curve of the rear of the body portion 22.

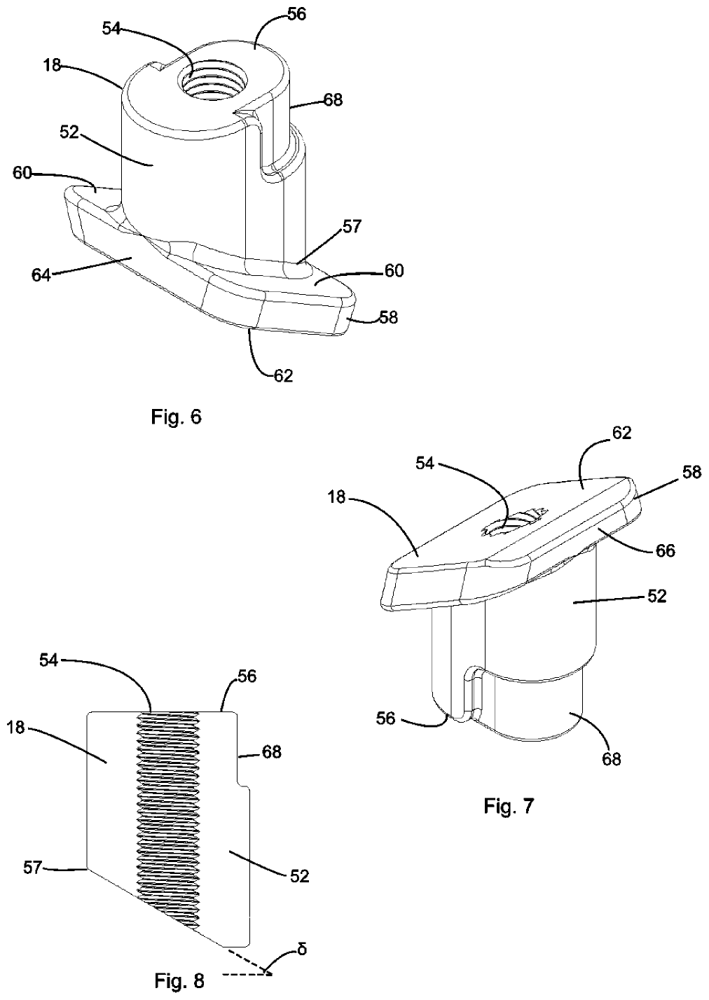

The second locking member 18 is shown in FIGS. 6 to 8. The second locking member 18 has a body portion 52 which is generally prismatic based on the same stadium shape and size as the body portion 22 of the first locking member 16. The body portion 52 has a threaded axial bore 54 passing therethrough.

The body portion 52 has an inner end 56 which is perpendicular to the threaded axial bore 54, and an outer end 57 which is inclined relative to the threaded axial bore 54. A collar 58 extends around the inclined outer end 57 of the body portion 52. The collar 58 is angled at an acute angle relative to the inner end 56. The acute angle o is the same as that of the collar 34 of the first locking member 16; that is, in the embodiment of the drawings, the acute angle δ is about 30°.

The collar 58 extends beyond the body portion 52 on two lateral sides of the second locking member 18. This creates a lip on each side, each lip having a surface facing towards the inner end 56. These surfaces act as guiding surfaces 60 for the second locking member 18.

The collar 58 has a generally annular outer surface, which forms an outer facing surface 62 for the second locking member 18. The outer facing surface 62 is parallel to the guiding surfaces 60; that is, is angled at the acute angle δ relative to the inner end 56.

The collar 58 has a front wall 64 and a rear wall 66. The front wall 64 and the rear wall 66 are parallel to each other, and perpendicular to the inner end 56.

The second locking member 18 has a receiving portion being a cut-out 68 around a rear of the body portion 52, extending axially from the inner end 56. The cut-out 68 is complementary in shape to the skirt 50 of the first locking member 16.

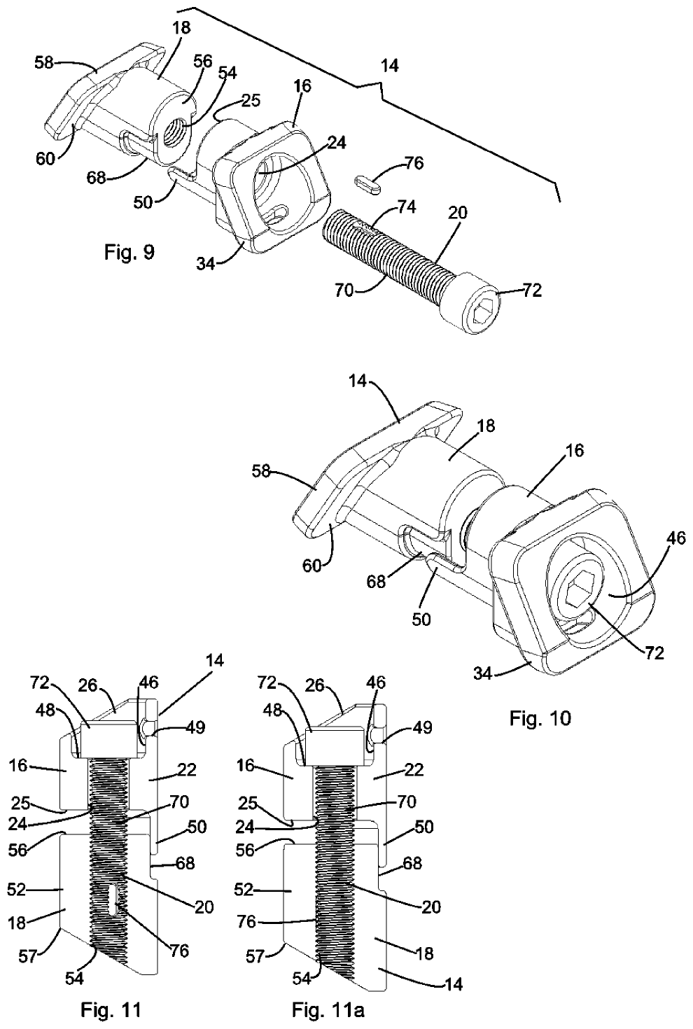

The assembled configuration of the lock 14 is shown in FIGS. 9 to 11. The first locking member 16 and the second locking member 18 are brought together such that their inner ends 25, 56 face each other, and the skirt 50 locates in the cut-out 68. In this way the axial bore 24 and the threaded axial bore 54 are axially aligned.

The bolt 20 has a threaded shank 70 sized to engage with the threaded axial bore 54, and a head 72 sized to locate within the wider cylindrical aperture 46 of the head receiving region 26 and to seat against the annular seat 48. The threaded shank 70 is passed through the axial bore 24 of the first locking member 16 and engages with the threaded axial bore 54 of the second locking member 18 to hold the first and second locking members 16, 18 together as shown in FIG. 10.

The threaded shank 70 includes a longitudinally aligned recess 74 arranged to receive a torque locking strip 76. The torque locking strip 76 acts to resist vibration and loosening of the lock 14.

It will be appreciated that the cross sectional shape of the assembled lock 14 is loosely trapezoidal; that is, the collar 34 of the first locking member 16 and the collar 58 of the second locking member 18 are inclined towards each other. The angle between them is thus the sum of the two acute angles α+δ; i.e., about 60°.

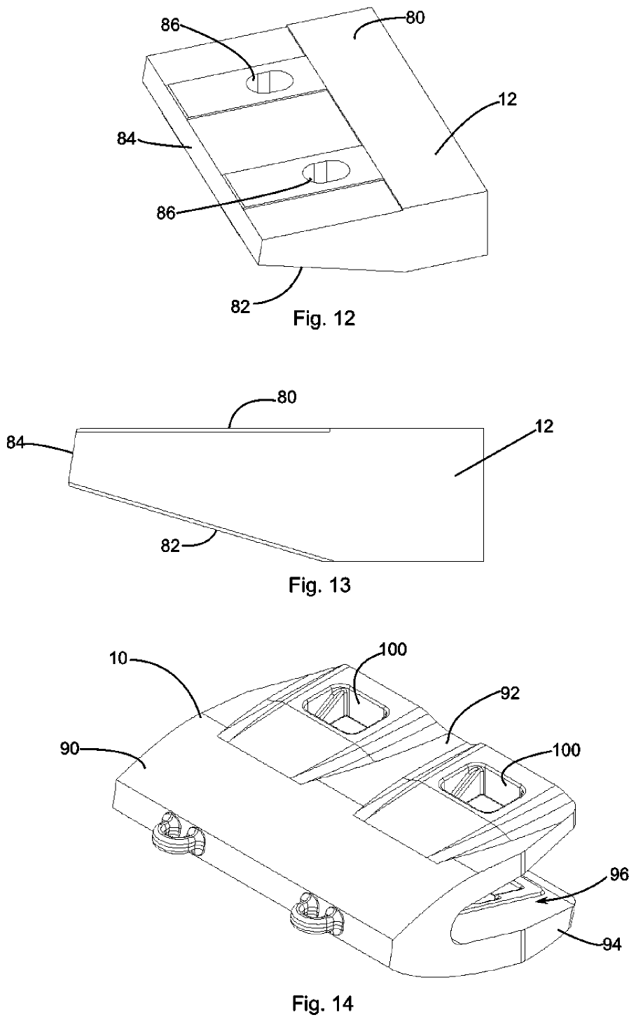

FIGS. 12 and 13 show a portion of a bucket edge 12 of an excavator bucket. The bucket edge 12 has an outer face 80 and an inner face 82, separated by a leading edge 84. The inner face 82 has a slight taper relative to the outer face 80.

The bucket edge 12 includes two laterally spaced apertures 86 extending between the outer face 80 and the inner face 82. Each of the apertures 86 is generally stadium shaped in cross section. The stadium shape has ends with a radius of curvature slightly greater than that of the body portion 22 of the first locking member 16, and straight edges about 50% longer than those of the body portion 22 of the first locking member 16. The apertures 86 are oriented such that their straight sides are perpendicular to the leading edge 84.

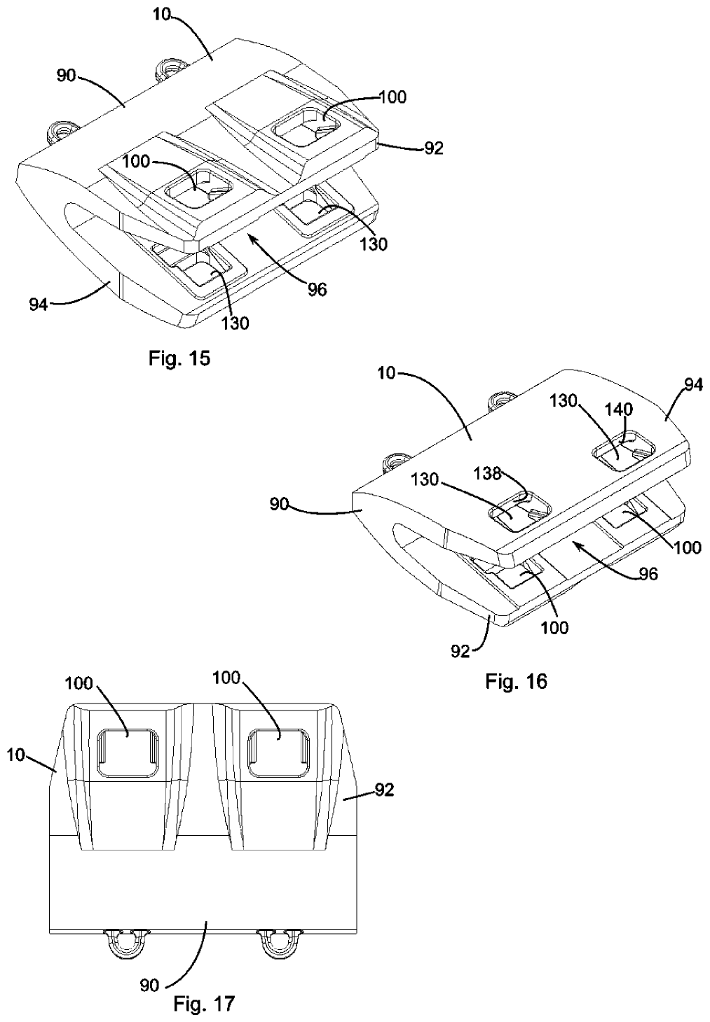

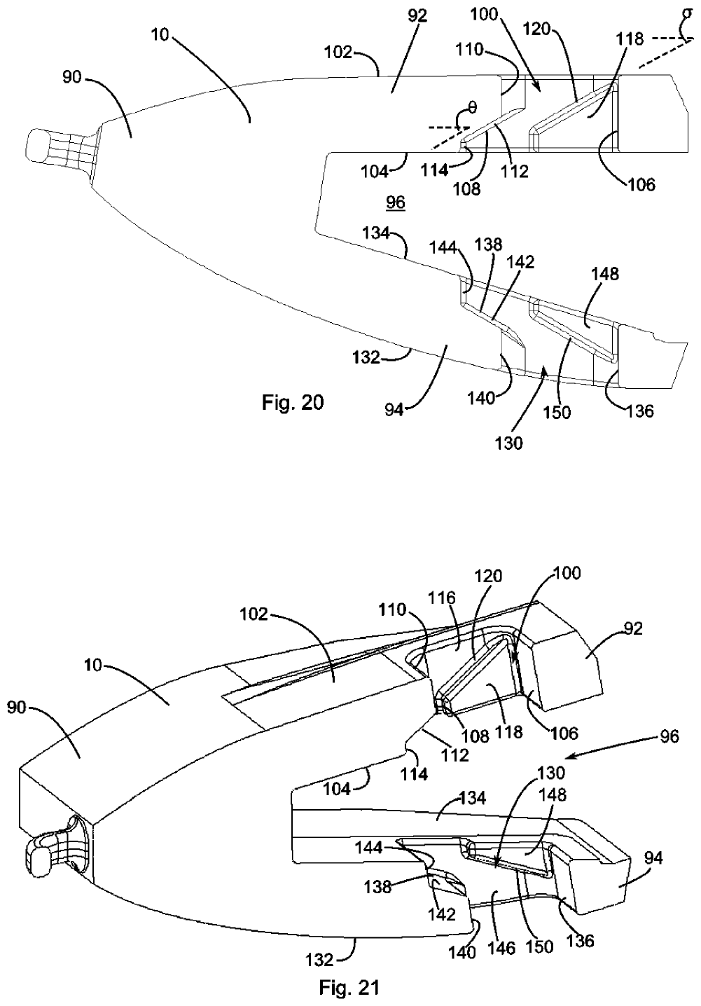

FIGS. 14 to 21 show a wing shroud 10 arranged to locate about the bucket edge 12. The wing shroud 10 has a forward portion 90 which forms a sacrificial wear portion, in use; and a first leg 92 and a second leg 94 which extend rearwardly of the forward portion 90 and which combine to form a cavity 96 sized to receive the bucket edge 12. The wing shroud 10 has a longitudinal direction; being the direction in which the wing shroud 10 is moved to locate on the bucket edge 12. In use, the longitudinal direction is parallel to the outer face 80 of the bucket edge 12, and perpendicular to the leading edge 84.

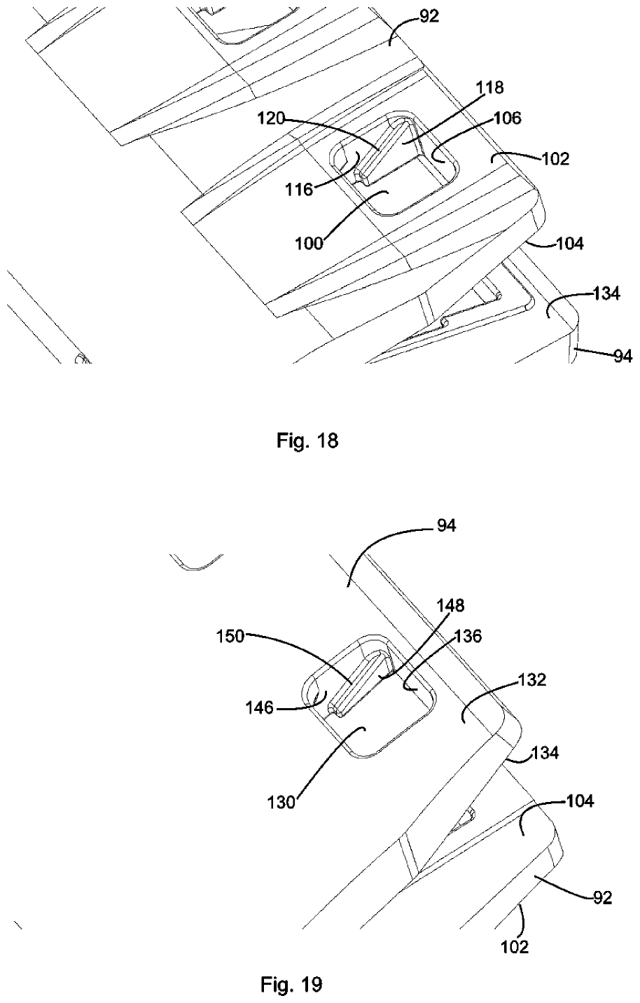

The first leg 92 includes two laterally spaced first lock receiving apertures 100. The first lock receiving apertures 100 are laterally spaced by a distance corresponding to the apertures 86 of the bucket edge 12, such that when the wing shroud 10 is located over the bucket edge 12 the first lock receiving apertures 100 locate over the apertures 86 of the bucket edge 12. The first lock receiving apertures 100 are identical, and one first lock receiving aperture 100 is shown in greater detail in FIG. 18.

The first lock receiving aperture 100 extends between an outer face 102 of the first leg 92 and an inner face 104 of the first leg 92. The first lock receiving aperture 100 has a rear wall 106 which extends from the outer face 102 to the inner face 104, and which is perpendicular to the outer face 102. The first lock receiving aperture 100 has a front wall 108 having three portions: an outer portion 110 extending from the outer face 102 towards the inner face 104, the outer portion 110 being parallel to the rear wall 106; an angled surface 112 extending inwardly from the outer portion 110 at an angle away from the rear wall 106; and an inner lip portion 114, the inner lip portion 114 extending from the inner face 104 towards the outer face 102, the inner lip portion 114 being parallel to the rear wall 106. The outer portion 110 extends through about half of the distance between the outer face 102 and the inner face 104. The inner lip portion 114 extends through about 15% of this distance.

The angled surface 112 is angled at an acute angle θ relative to the longitudinal direction of the wing shroud 10. This acute angle θ is the same as the acute angle α of the collar 34; that is, about 30°.

The distance between the outer portion 110 of the front wall 108 and the rear wall 106 is slightly greater than the distance between the front wall 44 of the collar 34 and the rear wall 30 of the head receiving region 26 of the first locking member 16.

The first lock receiving aperture 100 has two opposed side walls 116. The distance between the opposed side walls 116 is slightly greater than the lateral extent of the collar 34 of the first locking member 16.

Each of the side walls 116 has an inwardly projecting guide 118. The inwardly projecting guide 118 is right-triangular prismatic, with a base running along the inner face 104 of the first leg 92 and a side running along the rear wall 106. The hypotenuse of the right-triangle forms a guiding surface 120 which extends at an incline from the rear wall 106 and the outer face 102 towards the front wall 108 and the inner face 104. The guiding surface 120 forms an acute angle o relative to the longitudinal direction of the wing shroud 10. The guiding surface 120 is parallel to the angled surface 112 of the front wall 108; that is, is at an angle σ of about 30° relative to the longitudinal direction of the wing shroud 10.

The two projecting guides 118 are spaced apart by a distance slightly greater than the width of the head receiving region 26 between its two side walls 32, and smaller than the lateral extent of the collar 34 of the first locking member 16.

The arrangement is such that the first locking member 16 can locate within the first lock receiving aperture 100. As the first locking member 16 enters the first lock receiving aperture 100: the front wall 44 of the collar 34 loosely locates against the outer portion 110 of the front wall 108, and the rear wall 30 of the head receiving region 26 loosely locates against the rear wall 106 of the first lock receiving aperture 100.

The first locking member 16 can be entered into the first lock receiving aperture 100 until the guiding surfaces 36 of the first locking member 16 rest against the guiding surfaces 120 of the first lock receiving aperture 100. At this point the front wall 44 of the collar 34 just clears the outer portion 110 of the front wall 108 of the first lock receiving aperture 100.

The first locking member 16 can now move in a plane defined by the guiding surfaces 120 of the first lock receiving aperture 100, with the guiding surfaces 36 of the first locking member 16 moving along the guiding surfaces 120 of the first lock receiving aperture 100, and the outer facing surface 42 of the first locking member 16 moving along the angled surface 112 of the first lock receiving aperture 100. The angled surface 112 thus acts as an inner facing surface for the first lock receiving aperture 100.

The second leg 94 includes two laterally spaced second lock receiving apertures 130. The second lock receiving apertures 130 are laterally spaced and correspond to the positions of the first lock receiving apertures 100, such that when the wing shroud 10 is located over the bucket edge 12: the first lock receiving apertures 100, the apertures 86 of the bucket edge 12, and second lock receiving apertures 130 are all aligned. The second lock receiving apertures 130 are identical, and one second lock receiving aperture 130 is shown in greater detail in FIG. 19.

The second lock receiving aperture 130 extends between an outer face 132 of the second leg 94 and an inner face 134 of the second leg 94. The second lock receiving aperture 130 has a rear wall 136 which extends from the outer face 132 to the inner face 134, and which is co-planar to the rear wall 106 of the first lock receiving aperture 100. The second lock receiving aperture 130 has a front wall 138 having three portions: an outer portion 140 extending from the outer face 132 towards the inner face 134, the outer portion 140 being parallel to the rear wall 136; an angled surface 142 extending inwardly from the outer portion 140 at an angle away from the rear wall 136; and an inner portion 144, the inner portion 144 extending from the inner face 134 towards the outer face 132, the inner portion 144 being parallel to the rear wall 136. The outer portion 140 extends through about half of the distance between the outer face 132 and the inner face 134. The inner portion 144 extends through about 45% of this distance.

The angled surface 142 is angled at an acute angle relative to the longitudinal direction of the wing shroud 10. This acute angle is the same as the acute angle of the collar 58; that is, about 30°.

The distance between the outer portion 140 of the front wall 138 and the rear wall 136 is slightly greater than the distance between the front wall 64 and the rear wall 66 of the collar 58 of the second locking member 18.

The second lock receiving aperture 130 has two opposed side walls 146. The distance between the opposed side walls 146 is slightly greater than the lateral extent of the collar 58 of the second locking member 18.

Each of the side walls 146 has an inwardly projecting guide 148. The inwardly projecting guide 148 is right-triangular prismatic, with a base running along the inner face 134 of the second leg 94 and a side running along the rear wall 136. The hypotenuse of the right-triangle forms a guiding surface 150 which extends at an incline from about halfway up the rear wall 136 towards the front wall 138 and the inner face 134. The guiding surface 150 is parallel to the angled surface 142 of the front wall 138; that is, is at an angle of about 30° relative to the longitudinal direction of the wing shroud 10.

The two projecting guides 148 are spaced apart by a distance greater than the width of the body portion 52, and smaller than the lateral extent of the collar 58 of the second locking member 18.

The arrangement is such that the second locking member 18 can locate within the second lock receiving aperture 130. As the second locking member 18 enters the second lock receiving aperture 130 the front wall 64 of the collar 58 loosely locates against the outer portion 140 of the front wall 138, and the rear wall 66 of the collar 58 loosely locates against the rear wall 136 of the second lock receiving aperture 130.

The second locking member 18 can be entered into the second lock receiving aperture 130 until the guiding surfaces 60 of the second locking member 18 rest against the guiding surfaces 150 of the second lock receiving aperture 130. At this point the front wall 64 of the collar 58 just clears the outer portion 140 of the front wall 138 of the second lock receiving aperture 130.

The second locking member 18 can now move in a plane defined by the guiding surfaces 150 of the second lock receiving aperture 130, with the guiding surfaces 60 of the second locking member 18 moving along the guiding surfaces 150 of the second lock receiving aperture 130, and the outer facing surface 62 of the second locking member 18 moving along the angled surface 142 of the second lock receiving aperture 130. The angled surface 142 thus acts as an inner facing surface for the second lock receiving aperture 130.

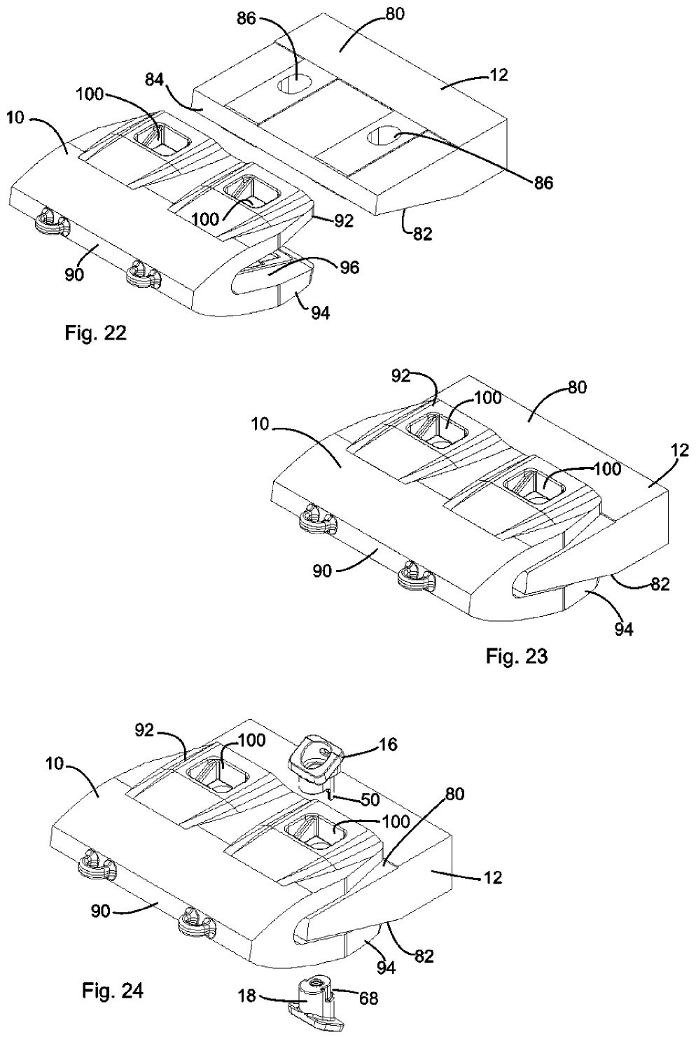

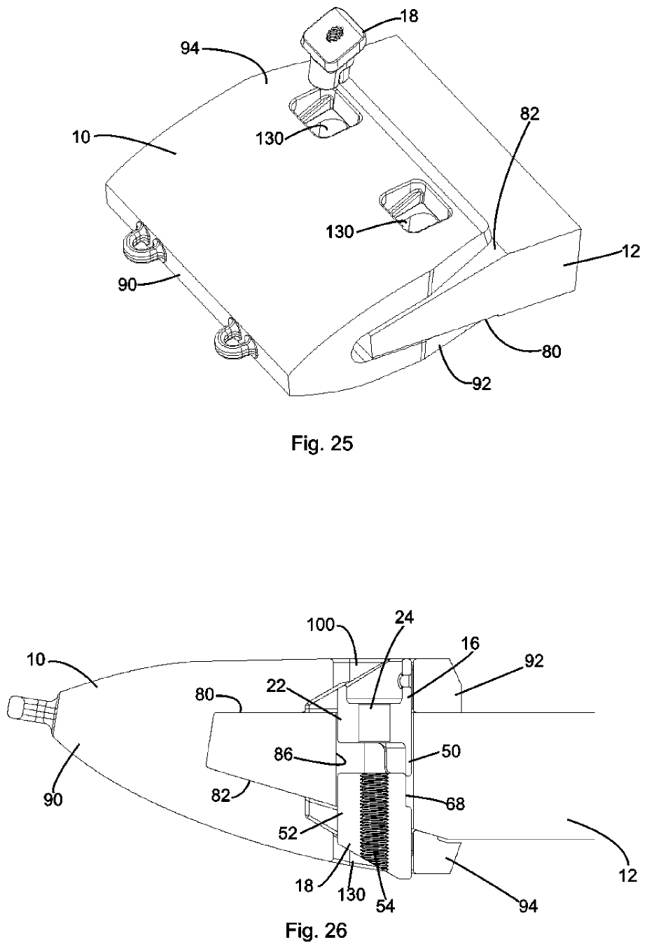

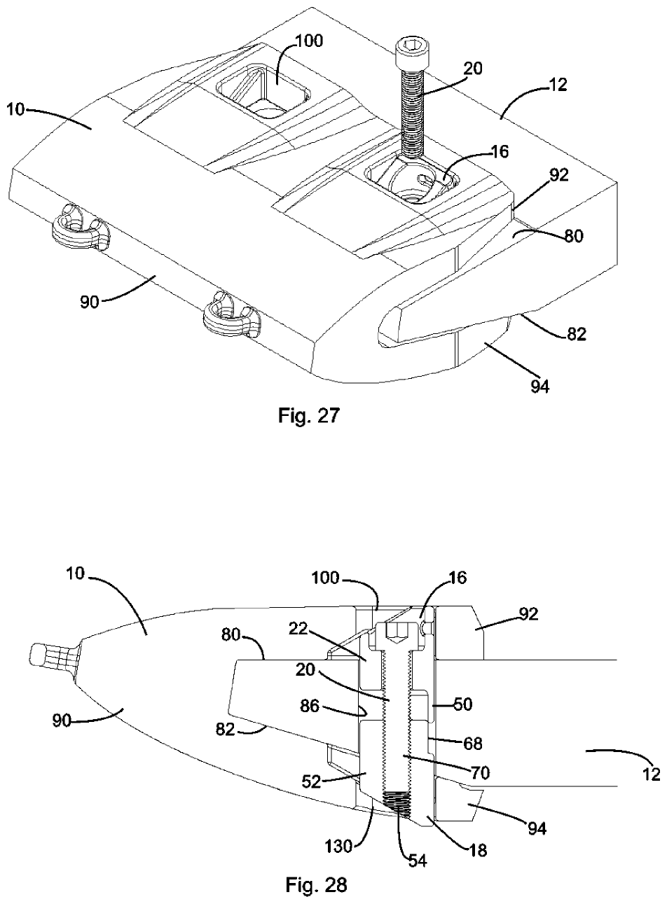

Locking of the wing shroud 10 to the bucket edge 12 will now be described with reference to FIGS. 22 to 28.

The wing shroud 10 is slid in the longitudinal direction onto the bucket edge 12 with the leading edge 84 locating within the cavity 96 until the inner face 104 of the first leg 92 abuts the outer face 80 of the bucket edge 12, and the inner face 134 of the second leg 94 abuts the inner face 82 of the bucket edge 12. Each pair of aligned first and second lock receiving apertures 100, 130 locate on either side of an aperture 86 of the bucket edge 12.

A first locking member 16 is positioned in each first lock receiving aperture 100 and a second locking member 18 is positioned in each second locking aperture 130. In each case the skirt 50 of the first locking member 16 locates within the cut-out 68 of the second locking member 18, facing a rear wall of the aperture 86. A front surface of the body portions 22, 52 abuts a front wall of the aperture 86. This arrangement is shown in cross section in FIG. 26.

The bolt 20 is introduced via the axial bore 24 of the first locking member 16 and threaded into the threaded axial bore 54 of the second locking member 18. This arrangement is shown in cross section in FIG. 28.

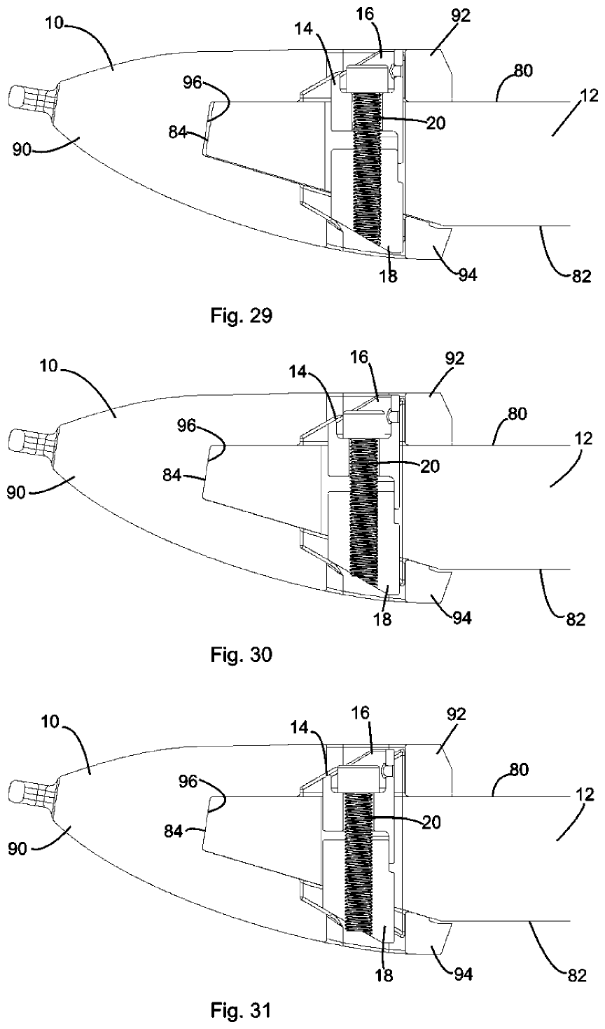

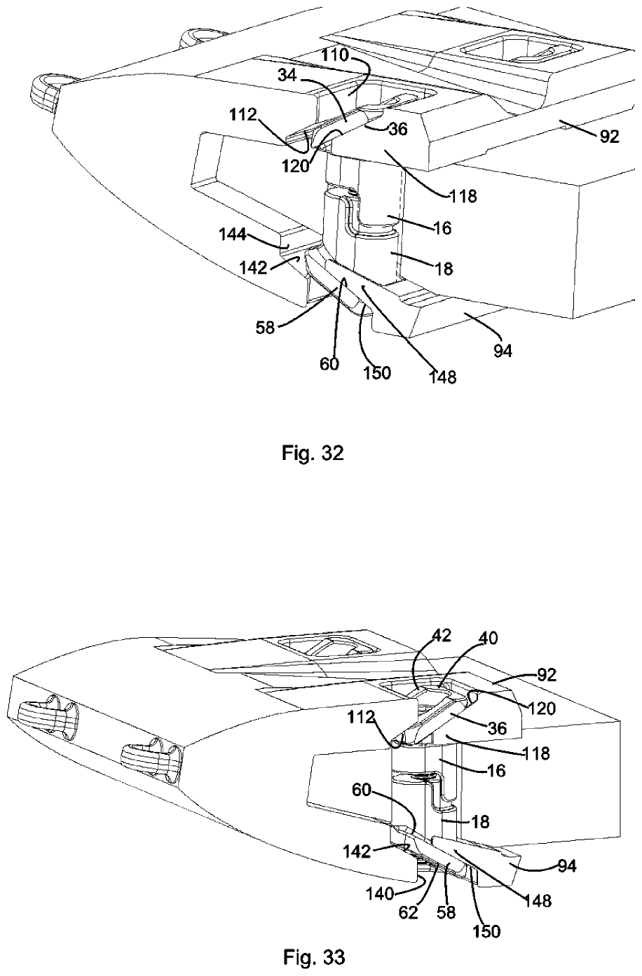

Tightening of the bolt 20 causes the first locking member 16 to move axially towards the second locking member 18, reducing the distance between the collar 34 of the first locking member 16 and the collar 58 of the second locking member 18. This causes the guiding surfaces 36, 60 of the collars 34, 58 to bear against the guiding surfaces 120, 150 of the wing shroud 10, thus forcing the wing shroud 10 rearwardly in the longitudinal direction relative to the bucket edge 12. This tightening is shown in FIGS. 29 to 31. The action of the guiding surfaces 36, 60 against the guiding surfaces 120, 150 is shown in FIGS. 32 and 33.

This tightening can continue until the leading edge 84 of the bucket edge 12 abuts the inside of the forward portion 90 of the wing shroud 10. In this position the wing shroud 10 is tightly locked against the bucket edge 12. Should any of the components wear slightly, and the lock 14 become loose, the bolt 20 can be further tightened to remove any looseness.

The wing shroud 10 can be removed by unwinding and removal of the bolts 20, and then the first and second lock members 16, 18 can be readily pried out from their position.

Modifications and variations as would be apparent to a skilled addressee are deemed to be within the scope of the present invention.

1. A lock for a ground engaging tool, the lock having a first locking member, a second locking member and a tightening element;
the first locking member having an axial bore;
the second locking member having an axial bore;
the tightening element arranged to locate with the axial bores of the first and second locking members, defining an axial direction of the lock;
a transverse plane of the lock being defined as perpendicular to the axial direction;
the first locking member having at least one guiding surface, the guiding surface facing generally towards the second locking member, the guiding surface being located on a lateral side of the first locking member, the guiding surface being oriented at an acute angle relative to the transverse plane.

2. A lock for a ground engaging tool as claimed in claim 1, wherein the first locking member has two guiding surfaces, the two guiding surfaces being located on opposite transverse sides of the first locking member, the two guiding surfaces being co-planar.

3. A lock for a ground engaging tool as claimed in claim 1, wherein the acute angle is between 20° and 60°.

4. A lock for a ground engaging tool as claimed in claim 3, wherein the acute angle is between 20° and 45°.

5. A lock for a ground engaging tool as claimed in claim 4, wherein the acute angle is about 30°.

6. A lock for a ground engaging tool as claimed in claim 1, wherein the first locking member has an outer facing surface, the outer facing surface facing generally away from the second locking member, the outer facing surface being generally parallel to the guiding surface.

7. A lock for a ground engaging tool as claimed in claim 1, wherein the first locking member has an axially aligned body portion, and a collar extending laterally of the body portion at an outer end thereof, the collar being oriented at the acute angle relative to the transverse plane.

8. A lock for a ground engaging tool as claimed in claim 1, wherein the second locking member has at least one guiding surface, the guiding surface facing generally towards the first locking member, the guiding surface being located on a lateral side of the second locking member, the guiding surface being oriented at an acute angle relative to the transverse plane.

9. A lock for a ground engaging tool as claimed in claim 8, wherein the acute angle of the second locking member guiding surface is the same as that of the first locking member guiding surface.

10. A lock for a ground engaging tool as claimed in claim 8, wherein the second locking member has two guiding surfaces, located on opposite lateral sides of the second locking member.

11. A lock for a ground engaging tool as claimed in claim 8, wherein the second locking member has an axially aligned body portion, and a collar extending laterally of the body portion at an outer end thereof, the collar being oriented at the acute angle relative to the transverse plane.

12. A lock for a ground engaging tool as claimed in claim 1, wherein the first locking member has an axially extending locating portion, and the second locking member has a complementary receiving portion.

13. A lock for a ground engaging tool as claimed in claim 1, wherein the tightening element is an externally threaded bolt, and one of the first and second locking members includes an enlarged region in which a head of the bolt may be received, and the other of the first and second locking members has an internally threaded bore in which a shank of the bolt can be engaged.

14. A ground engaging tool having a longitudinal direction, the ground engaging tool having two legs arranged to locate about an excavator bucket edge, a first leg including a first lock receiving aperture and a second leg including a second lock receiving aperture, the first and second lock receiving apertures being aligned;
the first lock receiving aperture having two lateral sides,
at least one lateral side including a guiding surface, the guiding surface being oriented at a first acute angle relative to the longitudinal direction, the guiding surface facing away from the second lock receiving aperture; and
the first lock receiving aperture including an inner facing surface, the inner facing surface being oriented at a second acute angle relative to the longitudinal direction, the inner facing surface facing towards the second lock receiving aperture.

15. A ground engaging tool as claimed in claim 14, wherein the first and second acute angles are preferably-both between 20° and 60°.

16. A ground engaging tool as claimed in claim 15, wherein the first and second acute angles are both between 20° and 45°.

17. A ground engaging tool as claimed in claim 16, wherein the first and second acute angles are both about 30°.

18. A ground engaging tool as claimed in claim 14, wherein both lateral sides include a guiding surface, the two guiding surfaces being parallel to each other and co-planar.

19. A ground engaging tool as claimed in claim 14, wherein the first lock receiving aperture has a front surface with at least two portions, a first portion extending inwardly from an outer surface of the ground engaging tool, and a second portion extending inwardly and forwardly from the first portion, the second portion forming the inner facing surface.

20. A ground engaging tool as claimed in claim 19 wherein the guiding surface extends from a rear surface of the first lock receiving aperture to a termination point, the termination point being located about midway between the rear surface and a forward-most edge of the second portion of the front surface.

21. A method of attaching a ground engaging tool to a bucket edge, the method including the steps of:
providing at least one aperture passing through the bucket edge;
locating the ground engaging tool about the bucket edge such that two legs of the ground engaging tool are positioned about the excavator bucket edge, a first leg including a first lock receiving aperture and a second leg including a second lock receiving aperture, the first and second lock receiving apertures being aligned with the aperture of the bucket edge, the first lock receiving aperture having a guiding surface oriented at an acute angle relative to a longitudinal direction of the ground engaging tool;
locating a first locking member in the first lock receiving aperture such that a guiding surface of the first locking member is oriented at an acute angle relative to the longitudinal direction of the ground engaging tool;
locating a second locking member in the second lock receiving aperture;
connecting axial bores of the first and second locking members by a tightening element; and
tightening the tightening element to cause the guiding surface of the first locking member to bear against the guiding surface of the first lock receiving aperture, thus urging the ground engaging tool rearwardly relative to the bucket edge.
